(19) United States
(12) Patent Application Publication
(10) Pub. No.: US 2020/0104843 A1
(43) Pub. Date: Apr. 2, 2020

(54) METHOD AND SYSTEM FOR INCREASING TRANSACTION ACCURACY AND SPEED

(71) Applicant: Visa International Service Association, San Francisco, CA (US)

(72) Inventor: Gurpreet Singh Bhasin, Fremont, CA (US)

(21) Appl. No.: 16/148,929

(22) Filed: Oct. 1, 2018

(51) Int. Cl. G06Q 20/40; G06Q 40/02

(52) U.S. Cl. CPC G06Q 20/40; G06Q 40/025

(57) ABSTRACT

Methods and computing systems are disclosed for improving the speed and accuracy of transaction decisioning processing. A method includes receiving on a continual and real time basis, a plurality of indications associated with a user from a plurality of external data sources, generating a score based upon the plurality of indications, receiving an authorization request message for a transaction, applying, by the computer, the score to the authorization request message, and transmitting, by the computer, an authorization response message based upon the score.

### CROSS-REFERENCE TO RELATED APPLICATIONS

None.

### BRIEF SUMMARY

The present disclosure contemplates methods and computing systems (e.g., prediction systems, such as delinquency prediction systems) for improving real-time decision processing for transactions, such as transactions to access data and payment transactions.

One embodiment includes a method comprising: receiving, by a computer, on a continual and real time basis, a plurality of indications associated with a user from a plurality of external data sources; generating, by the computer, a score based upon the plurality of indications; receiving, by the computer, an authorization request message for a transaction; applying, by the computer, the score to the authorization request message; and transmitting, by the computer, an authorization response message based upon the score.

Another embodiment includes a computing system comprising: one or more processors; and non-transitory memory containing instructions that, when executed by the processor, cause the one or more processors to perform a method comprising: receiving on a continual and real time basis, a plurality of indications associated with a user from a plurality of external data sources; generating a score based upon the plurality of indications; receiving an authorization request message for a transaction; applying the score to the authorization request message; and transmitting an authorization response message based upon the score.

These and other embodiments are described in detail below.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 is a block diagram illustrating an access system, according to one or more embodiments.

FIG. 2 is a block diagram with an access system and a detailed breakdown of a prediction system in the access system, according to one or more embodiments.

FIG. 3 is a block diagram with an access system and a detailed breakdown of a prediction system in the access system, according to one or more embodiments. A process flow is also illustrated in FIG. 3.

While each of the figures illustrates a particular embodiment for purposes of illustrating a clear example, other embodiments may omit, add to, reorder, and/or modify any of the elements shown in the figures.

### DETAILED DESCRIPTION

There are a number of situations in which decisions need to be made regarding whether or not to allow a user to conduct an interaction, such as a transaction. In one example, a user may wish to use an access device, such as a communication device, in order to access secure data on a remote server computer. In such situations, the remote server computer needs to decide whether or not to allow the user access to the secure data. The remote server computer can simply evaluate an authorization request message requesting access (e.g., sent by the access device) to determine if it appears to be authentic. To have a greater confidence level that the authorization request message from the access device is authentic, however, the remote server computer could contact external data sources to obtain more information about the access request. For example, the remote server computer can access an external data source which can examine the Internet Protocol (IP) address of the access device. An IP address is a numerical label assigned to each device connected to a computer network that uses the Internet Protocol for communication, and it is typically used for device identification and location addressing. Thus, the remote server computer may examine the IP address of the access device to determine if the IP address is on a blacklist of potentially fraudulent IP addresses. However, contacting external data sources during an access request in order to pull data from those external data sources can significantly delay the time in evaluating the request and allowing the user to access the secure data. This is undesirable.

In another example, when issuers (e.g., a financial entity) issue credit cards to an individual, they bear financial risk if the individual becomes delinquent on the card and is unable to pay the balance accrued on the payment account. For this reason, an issuer may be concerned with the likelihood that a particular credit card issued to an individual will become delinquent. The issuer of the card may not wish to authorize transactions on a card that will likely push the card into delinquency, or if the card is already likely to be delinquent, the issuer of the card may not wish to authorize any transactions at all.

However, issuers may lack the necessary data needed to accurately predict whether a payment account will be delinquent, or whether a particular transaction carries a high risk of causing a payment account to be delinquent. For instance, an issuer may have limited historical data (e.g., of past transactions and past delinquencies) for the individual associated with that payment account. The issuer may only have access to data associated with payment accounts that it has issued, and thus data for that individual may be limited to the individual's payment accounts provided by that issuer, which may often be a single payment account. Thus, the delinquency protection of an issuer may be predicated on the available data that particular issuer has for a given individual.

Issuers may attempt to supplement the data they have regarding a particular individual using external sources. For example, the issuer may be able to reach out to credit bureaus and credit reporting agencies (e.g., Equifax) in order to obtain credit scores and credit reports, which can help obtain a more complete financial picture of the individual. However, gathering supplemental data from external sources during a real time interaction will be too slow to be useful. In a typical a typical credit card authorization process, an authorization request message is sent from a merchant point of sale terminal to an issuer computer, and the issuer computer returns an authorization response message. This process generally takes about 5 seconds in a typical situation. If this conventional credit card authorization process is modified to include a method including generating a communication to an external data source (such as third-party credit bureaus or a credit reporting agency), searching records for additional data by the external data source, and receiving a response from the external data source with the additional information, it could double or even triple the total time to authorize the credit card transaction.

Another problem that exists with communicating with external data sources, is that the data from the external data sources may not be complete for a particular user and/or may be not be enough information to determine if a user has a high likelihood of becoming delinquent and therefore unable to pay for the current transaction. In particular, lenders generally report positive and negative information to credit bureaus on a monthly basis, and different lenders associated with a particular individual may report to the credit bureaus at different points of each month. Thus, even though a credit bureau may calculate an updated credit score upon request, that calculation may not factor in updated information from all the lenders and the credit score may fluctuate throughout the month. This delay also means that credit scores, as they are traditionally implemented, are still an incomplete financial picture of an individual and are best suited for conveying an individual's past ability to pay on a longer historical time frame. As a result of the traditional credit score being unable to capture an individual's behavior and transactions in real-time, it is not well-suited for detecting potential delinquent patterns of behavior on a shorter time frame (e.g., on an intra-month scale) or predicting an individual's future ability to pay.

Thus, improved transaction processing systems and methods are needed, and embodiments can address any of these problems.

In the present disclosure, methods and computing systems (e.g., prediction systems, such as delinquency prediction systems) are proposed for improving real-time decision processing for transactions, such as transactions to access data and payment transactions. For instance, these methods and computing systems can be used for real-time decision processing for credit card payment transactions. These methods and computing systems can be used for predicting and preventing credit card delinquency using predictive models which utilize all the available, up-to-date historical payment account data (e.g., data accrued over the use of a payment account, such as data of past transactions, past delinquencies, past credit limits, past credit utilization, and so forth) for any particular individual, such as the data associated with all the payment accounts for the individual across multiple issuers, as well as all the available, up-to-date historical payment account data for all individuals issued cards by the multiple issuers. Thus, predictions of a particular individual's delinquency on a card can be made based on either the behavioral patterns of all other individuals that became delinquent under a similar context (e.g., collective behavior) or the behavioral patterns of that particular individual (e.g., individual behavior). Issuers may enable these predictive methods and computing systems to generate predictions in real-time in response to authorization request messages (e.g., from a processor computer) and automatically reject transactions that are likely to be associated with delinquency, or issuers may retain the role of the authorizing entity while factoring in the predictions into their own risk models.

Prior to discussing the details of some embodiments of the present invention, description of some terms may be helpful in understanding the various embodiments.

A “processor” may include any suitable data computation device or devices. A processor may comprise one or more microprocessors working together to accomplish a desired function. The processor may include a central processing unit (CPU), which is the electronic circuitry within a computing device that carries out the instructions of a computer program by performing the basic arithmetic, logical, control and input/output (I/O) operations specified by the instructions. The CPU may comprise at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

An “application” may be computer code or other data stored on a computer readable medium (e.g. memory element or secure element) that may be executable by a processor to complete a task.

An “access device” may be any suitable device for providing access to an external computer system. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a portable communication device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a portable communication device.

An “authorization request message” may be an electronic message that is sent to request authorization for an interaction. The authorization request message can be sent to a processor computer in a payment processing network (e.g., a payment processor) and/or an issuer of a payment card. An authorization request message according to some embodiments may comply with ISO 8583, which is a standard for systems that exchange electronic transaction information associated with a payment made by a user using a payment device or payment account. The authorization request message may include information that can be used to identify an account (e.g., information for a token). An authorization request message may also comprise additional data elements such as one or more of a service code, an expiration date, etc. An authorization request message may also comprise transaction information, such as any information associated with a current transaction, such as an identification of the virtual good or service, a transaction amount, a merchant identifier, a merchant location, etc., as well as any other information that may be utilized in determining whether to identify and/or authorize a transaction.

An “authorization response message” may be an electronic message reply to an authorization request message. The authorization response message can be generated by an issuing financial institution (e.g., an issuer) or a processor computer such as a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant computer that indicates approval of the transaction. The code may serve as proof of authorization.

An “application programming interface” or “API” may be a set of routines, protocols, and tools that specify how system components should interact. The API may allow various components of a system to generate, send, and receive to and from each other in a recognizable format. The API may be preconfigured, installed, or programmed onto a device, and may instruct the device to perform specified operations and networking commands. The API may allow for the request of services by initiating calls to specific instructions or code stored in an application.

An “API message” may be a formatted message that facilitates communications between system components according to an application programming interface or API. The API message may allow system components to share data and initiate actions on each other's behalf. For example, an API message may comprise transaction data that may initiate a server computer to return a response based on the transaction data.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

A “payment credential” may include any suitable credential that can be used to conduct a payment transaction. Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV, dCVV, CVV2, and CVC3 may be examples of card security codes, which are a security feature for “card not present” payment card transactions instituted to reduce the incidence of credit card fraud in situations where a personal identification number (PIN) cannot be used.

An “authorizing entity” may be an entity that authorizes a request. Examples of an authorizing entity may be an issuer, a payment processing network (e.g., a payment processor), a governmental agency, a document repository, an access administrator, etc. An authorizing entity may operate an authorizing entity computer.

An “issuer” may include a business entity (e.g., a bank) that issues and optionally maintains an account for a user. An issuer may also issue payment credentials stored on a user device, such as a cellular telephone, smart card, tablet, or laptop to the consumer. In some cases, an issuer may issue and maintain a credit card account for a user and provide the user with a credit card to make transactions using the credit card account. In some cases, an issuer may be any financial entity that issues a credit card.

An “account identifier” may include an identifier for an account. An account identifier may include an original account identifier associated with a payment account. The account identifier may be in any suitable form and may include any suitable types of characters. Examples of account identifiers include PANs (primary account numbers), tokens, verification values such as CVVs, etc. For example, a real account identifier may be a primary account number (PAN) issued by an issuer for a card account (e.g., credit card, debit card, etc.). For instance, in some embodiments, a real account identifier may include a sixteen digit numerical value such as “4147 0900 0000 1234.” The first six digits of the real account identifier (e.g., “414709”), may represent a real issuer identifier (BIN) that may identify an issuer associated with the real account identifier.

An “external data source” may be any suitable source of data that is external to and typically remote from a local system, such as a prediction system. External data sources may provide supplemental data to the prediction system to allow the prediction system to provide better predictions. Examples of external data sources may include different authorizing entities such as different issuers, different data providers, and governmental entities (or their computers). External data sources may supply different types of data including, but not limited to, delinquency data, account use data, data relating to blacklists or whitelists, analytical data, device verification data, address verification data, etc.

An “indication” associated with a user may include any suitable information pertaining to a user, such as information regarding an account associated with the user. Such information may include, but is not limited to, information about an account delinquency of a user's account (e.g., indications of delinquencies associated with accounts at the external service provides) and times any account became delinquent, an account utilization of a user's account (e.g., indications of account utilization), a credit limit of a user's account (e.g., indications of account limit), information about a device that the user is using (e.g., an IP address or device ID), credit score data regarding the user. Such information may also include, but is not limited to, information about a user's account being compromised (indications of compromise associated with accounts at the external service providers) and times that any accounts became compromised. Such information may also include any historical account data associated with a user's payment account (e.g., historical payment account data), such as historical events associated with that payment account and the times of their occurrence (e.g., past transactions, delinquencies, and so forth), current parameters associated with the payment account (e.g., the current credit limit, the current pre-configured threshold set by the issuer, the current debt load or balance, and so forth), changes in parameters associated with the payment account and the times of their occurrence (e.g., changes in the credit limit), identity details associated with the payment account (e.g., the account identifier for the payment account, the payment processor associated with the payment account, the issuer of the payment account, and so forth), and identity details for the individual associated with the payment account (e.g., the name, address, social security number, and so forth, of the individual tied to the payment account).

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs.

A “machine learning classifier” may include a machine learning model that can classify input data or feature vectors. For example, an image classifier is a machine learning model that can be used to classify images, such as images of animals. As another example, a news classifier is a machine learning model that can classify news articles as “real news” or “fake news.” As a third example, an anomaly detector, such as a credit card fraud detector, can classify input data such as credit card transactions as either normal or anomalous. The output produced by a machine learning classifier may be referred to as “classification data.” Machine learning classifiers may also include clustering models, such as K-means clustering. Clustering models can be used to partition input data or feature vectors in to multiple clusters. Each cluster may correspond to a particular classification. For example, a clustering model may accept feature vectors corresponding to the size and weight of dogs, then generate clusters of feature vectors corresponding to small dogs, medium dogs, and large dogs. When new input data is included in a cluster (e.g., the small dogs cluster), the clustering model has effectively classified the new input data as input data corresponding to the cluster.

A “continual basis” may refer to the timing for sending and/or receiving new or updated data or information, such that any new or updated data or information of relevance is quickly sent and received once the new data is initially procured or the update occurs (e.g., within 24 hours). For instance, a source may track, store, and maintain indications associated with a user (e.g., any suitable information pertaining to a user) and also provide those indications to a recipient. When an individual indication changes or updates, that source may quickly (e.g., within 24 hours) send the updated indication to the recipient. Thus, the source in this example may be considered to be providing indications on a continual basis to the recipient, which is receiving the indications on a continual basis.

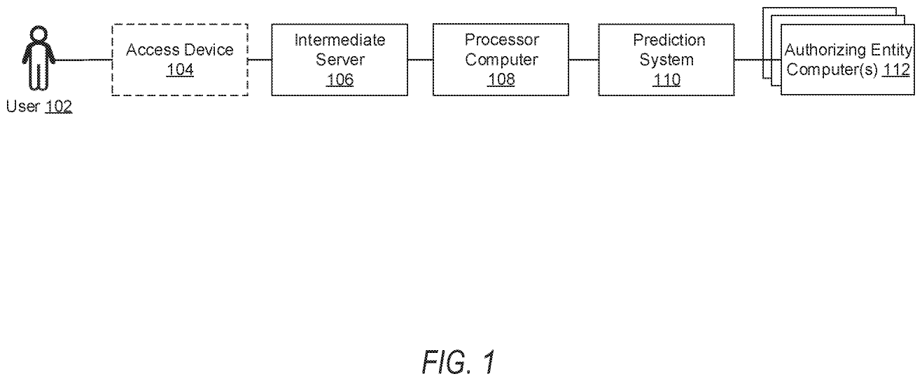

FIG. 1 is a block diagram illustrating an access system, which may include a prediction system (e.g., a delinquency prediction system) usable within the context of a transaction, in accordance with embodiments of the present disclosure.

Although FIG. 1 illustrates an embodiment in which a Prediction System 110 (e.g., a Delinquency Prediction System) is positioned between a single Processor Computer 108 (e.g., Visa) and Authorizing Entity Computer(s) 112. There may be multiple different processor computers (e.g., in different payment processing networks) linked to the Prediction System 110 in other examples. In this example, the Authorizing Entity Computer(s) 112 may be external data sources that provide data to the Prediction System 110. Each of those processor computers may be configured to received requests from any number of intermediate servers and not just the Intermediate Server 106 shown in FIG. 1. In order to conduct a transaction with an intermediate server, any user (and not just User 102 shown in the figure) may initiate the transaction with the intermediate server through an access device, such as Access Device 104 (optional). However, for the purposes of clarity and facilitating understanding, FIG. 1 and its accompanying description describe a single customer (User 102), a single access device (Access Device 104), a single intermediate server (Intermediate Server 106) (which may be a merchant payment server), and a single processor computer (Processor Computer 108) (which may be a payment processor computer).

In some embodiments, a User 102 may attempt to perform a transaction via an Access Device 104 (optional) and pay using a credit card payment account associated with the User 102. The Access Device 104 may take the transaction details and forward them to the Intermediate Server 106. The transaction details may include payment credentials, such as an account identifier of the credit card payment account of the User 102. In other embodiments, the User 102 may attempt to perform a transaction with the Intermediate Server 106 and directly provide the transaction details to the Intermediate Server 106. In either case, the Intermediate Server 106 may then forward the transaction details to a Processor Computer 108 (e.g., Visa). Typically, the Processor Computer 108 may send an authorization request message to Authorizing Entity Computer(s) 112 (e.g., an issuer computer operated by an issuer of the credit card payment account of the User 102) in order to obtain authorization for the transaction, and the Authorizing Entity Computer(s) 112 may send back an authorization response message with the decision. In other embodiments, the Access Device 104 and/or the Intermediate Server 106 can generate an authorization request message, which may be transmitted to the Processor Computer 108.

In some embodiments, a Prediction System 110 may bridge the communications between the Processor Computer 108 and the Authorizing Entity Computer(s) 112. Thus, instead of the Processor Computer 108 sending an authorization request message to an Authorizing Entity Computer(s) 112, the Processor Computer 108 may send the authorization request message to the Prediction System 110. The authorization request message may include transaction details (e.g., the account identifier of the credit card payment account used by the User 102, a transaction amount, etc.) or may be sent alongside transaction details to the Prediction System 110.

In some embodiments, the Prediction System 110 may be configured to obtain historical payment account data from all of the Authorizing Entity Computer(s) 112. The historical data for any payment account may include historical events associated with that payment account and the times of their occurrence (e.g., past transactions, delinquencies, and so forth), current parameters associated with the payment account (e.g., the current credit limit, the current pre-configured threshold set by the issuer, the current debt load or balance, and so forth), changes in parameters associated with the payment account and the times of their occurrence (e.g., changes in the credit limit), identity details associated with the payment account (e.g., the account identifier for the payment account, the payment processor associated with the payment account, the issuer of the payment account, and so forth), and identity details for the individual associated with the payment account (e.g., the name, address, social security number, and so forth, of the individual tied to the payment account). The Prediction System 110 may obtain historical payment account data for all payment accounts that were issued by all the Authorizing Entity Computer(s) 112.

In some embodiments, the Authorizing Entity Computer(s) 112 may continually provide updates, in real-time, with any material changes to the payment accounts or any material events associated with the payment accounts. Real time updates may occur as soon as the Authorizing Entity Computer(s) 112 know about changes or events that might cause the updates. For example, the Authorizing Entity Computer(s) 112 may inform of the occurrence of a material event associated with that payment account as it happens (e.g., transactions, delinquencies, and so forth), changes in parameters associated with the payment account as it happens (e.g., changes in the credit limit, the pre-configured threshold set by the issuer, the debt load or balance, credit utilization, and so forth), and changes in identity details for the individual associated with the payment account as it happens (e.g., the name, address, social security number, and so forth, of the individual tied to the payment account).

In some embodiments, after receiving information from the Authorizing Entity Computer(s) 112, the Prediction System 110 may save the various information associated with the payment accounts, such as the historical payment account data, into one or more databases.

In some embodiments, the Prediction System 110 may be configured to use machine learning techniques to build predictive models associated with predicting delinquency for payment accounts, with the historical payment account data obtained from the Authorizing Entity Computer(s) 112 serving as the training data. These predictive models may include predictive models based on collective behavior as a predictor of delinquency or on individual behavior as a predictor of delinquency.

Any suitable machine learning algorithm may be used in embodiments (e.g., the machine learning model can use linear regression, logistic regression, decision trees, support vector machines, naive Bayes, kNN, K-means, random forests, and the like that employs supervised learning, unsupervised learning or reinforcement learning, etc.). Examples of machine learning algorithms include linear regression, logistic regression, K-nearest neighbors, and support vector machines, among others. Linear regression models are predictive models that describe best-fit relationships between input variables and output variables by determining the coefficients of a linear function that relates the input variables and output variables. Logistic regression models are machine learning models that can be used for binary classification using a logistic function. K-nearest neighbors algorithms produce predictions for new data points based on some number (K) of training data points that are most similar to the new data point. Support vector machines are machine learning models that classify data points based on their position relative to a “hyperplane” that separates data points into different classes.

Some predictive models may be based on collective behavior and may be configured to predict a particular individual's delinquency on a card based on the behavioral patterns of all other individuals that became delinquent under a similar context. For example, X, Y, and Z events happened throughout the history of this individual's payment account and it can be predicted that this payment account is likely to be delinquent because the typical payment account with X, Y, and Z events is highly likely to be delinquent. The training data for such a predictive model would include the historical payment account data for all individuals issued cards by the multiple issuers, and the accuracy for such a predictive model would improve with having the historical payment account data for as many individuals and their payment accounts as possible.

Some predictive models may be based on individual behavior and may be configured to predict a particular individual's delinquency on a card based on the behavioral patterns of that particular individual in past delinquencies. For example, an individual may have become delinquent on two payment accounts after running up a balance in both accounts that was very close to the credit limit, and then the individual did not paying off a sizeable portion of that balance for X amount of time. If the individual has a third payment account in which the individual has run up the balance close to the credit limit for a certain amount of time, then it may be likely that this third payment account will also be delinquent. The training data for such a predictive model would include the historical payment account data for all the payment accounts for that particular individual. Since this predictive model is tailored to this particular individual and uses past behavioral patterns of that individual, its predictive capabilities may be reduced when applied to other individuals. Thus, a predictive model based on individual behavior may need to be generated for each individual. The accuracy of these predictive models may improve with having the historical payment account data for as many payment accounts of a particular individual as possible.

In some embodiments, these predictive models may factor in inputs that are generated by other predictive models (e.g., scoring models) in order to generate a delinquency prediction for a payment account associated with an individual. For example, these predictive models may factor in historical payment account data as inputs once those values for the historical payment account data have been converted to scores. For instance, if a predictive model factors in the credit limits and credit utilization of all the other cards used by an individual, then all the credit limits of the other cards may be used to generate a credit limit score and all the credit utilization of the other cards may be used to generate a credit utilization score. This credit limit score and credit utilization score may then be used in the predictive model for determining if the individual will likely be delinquent on the particular card for which a delinquency prediction is being generated.

In some embodiments, the Prediction System 110 may be able to apply the aforementioned predictive models in real-time to a credit card payment account being used in a transaction. For instance, when the Processor Computer 108 sends the authorization request message to the Prediction System 110 with transaction details (e.g., the account identifier of the credit card payment account used by the User 102), the Prediction System 110 may be able to use the predictive models in order to predict likelihood of delinquency for the credit card payment account associated with the transaction. These predictions can be based upon collective behavior and/or individual behavior depending on the model(s) used.

In some embodiments, the Authorizing Entity Computer(s) 112 of the credit card payment account associated with the transaction may have pre-authorized the Prediction System 110 to make transaction authorization or transaction rejection decisions based on its delinquency predictions or delinquency scores. For example, once the Prediction System 110 predicts the likelihood that the payment account associated with the transaction will be delinquent, and if it is very likely that the payment account will be delinquent (e.g., the chances are above a certain threshold), then the Prediction System 110 may be able to reject the transaction outright by sending an authorization response message back to the Processor Computer 108. If instead, the Prediction System 110 does not predict that the payment account is likely to be delinquent, then the Prediction System 110 can approve the transaction by sending an authorization response message back to the Processor Computer 108.

In some embodiments, if the Authorizing Entity Computer(s) 112 of the credit card payment account associated with the transaction has not pre-authorized the Prediction System 110 to make transaction authorization or transaction rejection decisions based on its delinquency predictions or delinquency scores, then the Prediction System 110 may modify the authorization request message with any scores and/or predictions, and may forward the modified authorization request message including transaction details and the delinquency predictions or scores to the Authorizing Entity Computer(s) 112 of the credit card payment account to make the decision regarding authorizing the transaction.

In some embodiments, the Prediction System 110 may broadcast updated delinquency predictions or delinquency scores associated with an individual to any Authorizing Entity Computer(s) 112 that have issued a credit card payment account to the individual. This broadcasting can be performed in place of modifying an authorization request message (e.g., by adding delinquency predictions or delinquency scores) and forwarding the modified authorization request message. In some cases, the Prediction System 110 may also push out delinquency predictions or delinquency scores to the Authorizing Entity Computer(s) 112 without having to be triggered by a transaction or request from the Authorizing Entity Computer(s) 112. For instance, this broadcast may be performed on a periodic basis (e.g., when the delinquency predictions or delinquency scores associated with any individual are updated). The receiving Authorizing Entity Computer(s) 112 may maintain their own databases, in which the updated delinquency predictions or delinquency scores for an individual can be stored and referenced.

As previously mentioned, in some embodiments, the Prediction System 110 may be configured to use machine learning techniques to build predictive models using historical payment account data for all payment accounts of the Authorizing Entity Computer(s) 112 as the training data. This historical payment account data for all the payment accounts of the will Authorizing Entity Computer(s) 112 may be directly obtained from each of the Authorizing Entity Computer(s) 112. In some embodiments, the Prediction System 110 may be able to aggregate, query, and manipulate all the data received from the Authorizing Entity Computer(s) 112, even though the data may be in different formats or standards, as well as received through different protocols. This feature uniquely enables the Prediction System 110 to generate delinquency predictions and delinquency scores based on all the available data across the Authorizing Entity Computer(s) 112 (e.g., financial entities such as banks), despite those Authorizing Entity Computer(s) 112 being unwilling or unable to directly communicate and share that data with one another.

Also, as previously mentioned, the Prediction System 110 has access to historical payment account data for all payment accounts of the Authorizing Entity Computer(s) 112 as the training data. The historical data for any payment account may include historical events associated with that payment account and the times of their occurrence (e.g., past transactions, delinquencies, and so forth). The transaction data for a payment account may include details associated with all the past transactions conducted by the payment account and the times of those transactions. The historical data for any payment account may also include current parameters associated with the payment account (e.g., the current credit limit, the current pre-configured threshold set by the issuer, the current debt load or balance, and so forth), changes in parameters associated with the payment account and the times of their occurrence (e.g., changes in the credit limit), identity details associated with the payment account (e.g., the account identifier for the payment account, the payment processor associated with the payment account, the issuer of the payment account, and so forth), and identity details for the individual associated with the payment account (e.g., the name, address, social security number, and so forth, of the individual tied to the payment account).

Some of the predictive models generated by the Prediction System 110 may require that all the payment accounts provided by the Authorizing Entity Computer(s) 112 for any particular individual be identified, so that the historical payment account data for all of those payment accounts can be grouped and considered together. This process may involve mapping payment accounts and their associated historical payment account data to a particular individual by matching the identity details for the individual associated with those payment accounts (e.g., the name, address, social security number, and so forth, of the individual tied to the payment account). In some embodiments, the Prediction System 110 may utilize a fuzzy matching process when matching the identity details for the individual associated with those payment accounts.

As a specific example of this, the Prediction System 110 may have, for a particular individual, historical payment account data associated with all the payment accounts issued to the individual by the Authorizing Entity Computer(s) 112, which may include Bank A, Bank B, and Bank C. All three banks may have provided a single credit card account to this individual, such that the individual has a credit card with Bank A, a credit card with Bank B, and a credit card with Bank C. Over time, this individual may utilize all three credit cards to conduct transactions to varying degrees. The historical payment account data (including all the transaction data) for all of these credit cards may be provided to the Prediction System 110 by the Authorizing Entity Computer(s) 112 (e.g., each issuer may furnish the historical payment account data for the respective credit card provided by that issuer). Thus, the Prediction System 110 may be able to access and evaluate transaction data associated with multiple payment accounts provided by multiple issuers (e.g., three credit cards from three separate issuers) that are associated with an individual. In other words, the Prediction System 110 may be able to utilize data from multiple issuers (e.g., financial entities) that would typically not be communicating and sharing data with one another. The Prediction System 110 is able to utilize this breadth of data from different issuers (e.g., financial entities) and different networks to determine delinquencies. This allows the Prediction System 110 to uniquely consider the cumulative credit limit and combined credit utilization across a number of cards issued to a particular individual.

In some embodiments, the Prediction System 110 may be affiliated with the Processor Computer 108, or the role of the Prediction System 110 may be fulfilled by the Processor Computer 108. However, having a Prediction System 110 that is separate from the Processor Computer 108 may confer distinct advantages, such as the ability to be used with different payment processors (e.g., Visa and MasterCard). As a specific example, consider that an individual may have a first credit card issued by Bank A that utilizes Payment Processor Computer A and a second credit card issued by Bank B that utilizes Payment Processor Computer B. The Prediction System 110 may have data associated with both credit cards, with the data being provided by both Bank A and Bank B. Both Payment Processor Computer A and Payment Processor Computer B may forward transaction details to the Prediction System 110. Thus, if the individual attempts to make a transaction using the first credit card, the Payment Processor Computer A will forward the transaction details to the Prediction System 110 which will make a decision regarding the delinquency. This decision will be based on data associated with both the first credit card from Bank A and the second credit card from Bank B rather than solely data associated with the first credit card from Bank A.

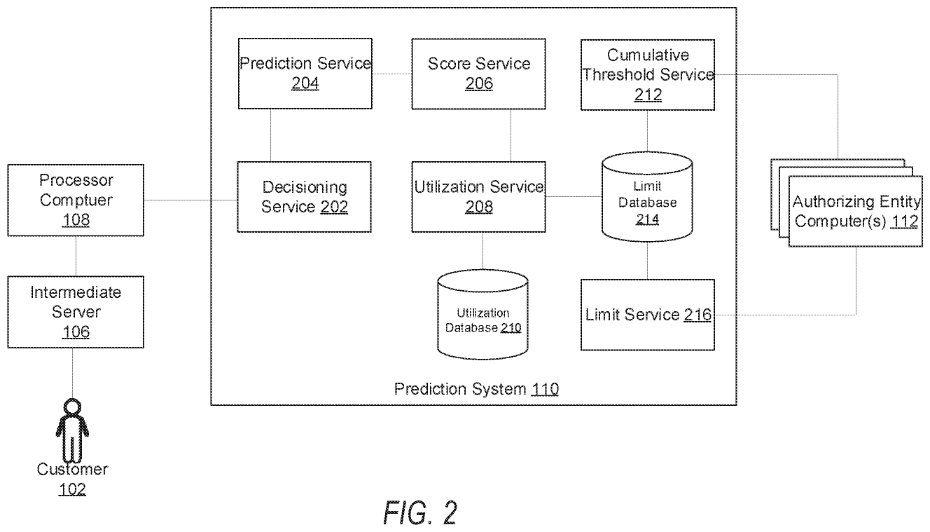

FIG. 2 is a block diagram with an access system and a detailed breakdown of a prediction system in the access system.

In some embodiments, the Authorizing Entity Computer(s) 112 may include any financial entity, such as a financial entity that issues a credit card. During an initialization step, the Authorizing Entity Computer(s) 112 may send historical payment account data for all payment accounts that were issued by all the Authorizing Entity Computer(s) 112 to the Prediction System 110. The historical data for any payment account may include historical events associated with that payment account and the times of their occurrence (e.g., past transactions, delinquencies, and so forth), current parameters associated with the payment account (e.g., the current credit limit, the current pre-configured threshold set by the issuer, the current debt load or balance, and so forth), changes in parameters associated with the payment account and the times of their occurrence (e.g., changes in the credit limit), identity details associated with the payment account (e.g., the account identifier for the payment account, the payment processor associated with the payment account, the issuer of the payment account, and so forth), and identity details for the individual associated with the payment account (e.g., the name, address, social security number, and so forth, of the individual tied to the payment account).

In some embodiments, the Authorizing Entity Computer(s) 112 may continually provide updates, in real-time, with any material changes to the payment accounts to the Prediction System 110. For example, the Authorizing Entity Computer(s) 112 may inform of the occurrence of a material event associated with that payment account as it happens (e.g., transactions, delinquencies, and so forth), changes in parameters associated with the payment account as it happens (e.g., changes in the credit limit, the pre-configured threshold set by the issuer, the debt load or balance, credit utilization, and so forth), and changes in identity details for the individual associated with the payment account as it happens (e.g., the name, address, social security number, and so forth, of the individual tied to the payment account).

The Prediction System 110 may also aggregate information from the various Authorizing Entity Computer(s) 112 for a single user based upon common data elements. For example, if the Authorizing Entity Computer(s) 112 include Bank A, Bank B, and Bank C, then each bank may have different credit card numbers for a single individual. However, additional universal information such as a name, address, or identification numbers (e.g., social security numbers) can be used to link data coming from different Authorizing Entity Computer(s) 112.

In some embodiments, the Authorizing Entity Computer(s) 112 may all provide updates on new payment accounts to the Prediction System 110. For example, whenever one of the Authorizing Entity Computer(s) 112 issues a new credit card, it may inform the Prediction System 110 with details associated with the payment account, such as the credit limit associated with the card, a pre-configured threshold set by the issuer, an account identifier associated with the card, and details of the individual that the card has been issued to.

In some embodiments, the information received by the Prediction System 110 may be received by one or more components of the Prediction System 110, such as the Cumulative Threshold Service 212 and/or the Limit Service 216. For example, historical payment account data (including data associated with credit card limits) may be received by the Limit Service 216, which may save the information in the Limit Database 214. Updates and changes to any payment account data may also be received by the Limit Service 216, which may save the information in the Limit Database 214. For instance, the Limit Service 216 may receive updates regarding any changes to the credit limit for a credit card, and the Limit Service 216 may modify the existing credit limit on file for that card within the Limit Database 214. Thus, the Limit Service 216 will manage and store payment account data for every payment account issued by the Authorizing Entity Computer(s) 112.

Similarly, historical payment account data for each credit card may be received by the Cumulative Threshold Service 212 of the Prediction System 110. This may include a pre-defined threshold for each credit card issued for an individual, and the Cumulative Threshold Service 212 may save that threshold in the Limit Database 214 alongside the other information for that card. This pre-defined threshold may be based on each issuer's risk profile and preferences. For instance, Bank A may issue a credit card to an individual with a $40,000 credit limit. The issuer will notify the Limit Service 216 of this credit limit, which will be saved in the Limit Database 214. In this example, Bank A may also define a threshold of $35,000 and provide that threshold to the Cumulative Threshold Service 212, which will save the threshold in the Limit Database 214 and associate it with the card. The issuer may select this threshold based on an associated risk of delinquency upon that threshold being reached. For instance, an issuer may discover that individuals who run up $35,000 of debt on a $40,000 credit limit will result in delinquencies after a certain time. Different issuers can select different thresholds for each card they issue to an individual and these thresholds are saved into the Limit Database 214. Updates and changes to any thresholds may also be received by the Cumulative Threshold Service 212, which may save the information in the Limit Database 214. For instance, the Cumulative Threshold Service 212 may receive updates regarding any changes to the threshold for a credit card, and the Cumulative Threshold Service 212 may modify the existing threshold on file for that card within the Limit Database 214.

In some embodiments, the Authorizing Entity Computer(s) 112 may also provide either the Limit Service 216 or the Cumulative Threshold Service 212 with delinquency data. This delinquency data may be part of the historical payment account data (e.g., received during initialization) or it may be sent separately. The delinquency data for a credit card may also include historical events or a historical timeline of the card leading up to delinquency, such as historical transactions, changes in credit limit, changes in debt load, and so forth. The Authorizing Entity Computer(s) 112 may also continually provide updated delinquency data on individuals that are delinquent on their account when a delinquency event occurs. For instance, when an individual becomes delinquent on a card, the issuer of that card may inform either the Limit Service 216 or the Cumulative Threshold Service 212 that the individual has become delinquent.

As previously mentioned, in order to factor in the details (credit limit, debt load, threshold, utilization) associated with multiple cards for a particular individual, those cards must all be matched to that individual. The cards can be matched based on any combination of the name, address, or social security number associated with those cards. For example, cards associated with the same name and same address may be presumed to be for the same individual. This can be performed by either the Limit Service 216 or the Cumulative Threshold Service 212 within the Limit Database 214.

In some embodiments, the Utilization Service 208 calculates, for each specific individual, their credit utilization across all of their payment accounts (e.g., credit card accounts) that are provided by the Authorizing Entity Computer(s) 112 and associated with a particular Processor Computer 108. In some embodiments, the Authorizing Entity Computer(s) 112 may periodically provide the Prediction System 110 with the debt load or balance associated with each card, and the Limit Service 216 may save that information in the Limit Database 214 or the Utilization Service 208 may save that information to the Utilization Database 210. The credit utilization of any card can be calculated using the credit limit of the card and the debt load on the card. Thus, in order to perform the calculation, the Utilization Service 208 may obtain each card's credit limit and debt load from the Limit Database 214 and/or the Utilization Database 210. For example, the Utilization Service 208 may calculate the utilization of all cards of a particular payment processor for an individual across multiple Authorizing Entity Computer(s) 112 (e.g., Chase, Bank of America, Wells Fargo, and so forth). The Utilization Service 208 may obtain all the credit limits and debt loads for those cards from the Limit Database 214, and then sum the credit limits and debt loads in order to determine the utilization of all VISA-based cards for the individual among all the Authorizing Entity Computer(s) 112.

In some embodiments, the Utilization Service 208 may update and maintain the utilization for each individual by storing the utilization in the Utilization Database 210. For instance, an individual may have been issued a first credit card from Bank A and a second credit card from Bank B, with both cards utilizing the same payment processor. The first credit card may have a credit limit of $10,000 and the second credit card may have a credit limit of $20,000, for a combined credit limit of $30,000. There may be $5,000 debt on the first credit card and $5,000 debt on the second credit card. Thus, the Utilization Service 208 may determine that 50% of the credit limit of the first credit card is being utilized while 25% of the credit limit of the second credit is being utilized. In some embodiments, the Utilization Service 208 may calculate the individual's overall credit utilization across all cards associated with that payment processor. In this example, between the two credit cards there is a total of $10,000 debt, which is ⅓rd of the combined credit limit of $30,000.

In some embodiments, the Utilization Service 208 may continually calculate and update an individual's overall credit utilization across all their payment accounts (e.g., credit card accounts) associated with a particular payment processor, based on updated data received from the Authorizing Entity Computer(s) 112. This data may include changes in credit limit for any of the cards and the amount of debt on each card after any financial event (e.g., a payment transaction, a balance transfer, a cash advance, a debt payment, and so forth). For instance, in the previous example, if Bank A raised the credit limit for the first credit card to $20,000, Bank A would provide this updated credit limit to the Limit Service 216, which may then save the information in the Limit Database 214. The Utilization Service 208 may determine that the credit limit for the first credit card has been updated and then retrieve this updated credit limit from the Limit Database 214. Since the first credit card now has a credit limit of $20,000 and the second credit card has a credit limit of $20,000, the combined credit limit is $40,000 and the total $10,000 debt is 25% of the combined credit limit. The Utilization Service 208 may save this calculated overall credit utilization for the individual in the Utilization Database 210.

In some embodiments, the Prediction System 110 may be configured to pre-emptively predict when a particular individual will be delinquent across many of their cards, based on number of factors which may include: overall credit utilization (e.g., as saved in the Utilization Database 210), the credit limit of each card (e.g., as saved in the Limit Database 214), the pre-defined threshold for each card (e.g., as saved in the Limit Database 214), and the debt load or credit utilization of each card (e.g., as saved in either the Utilization Database 210 or the Limit Database 214).

These predictions can be based on collective behavior or individual behavior. As an example of a prediction made on collective behavior, if an individual has three credit cards provided by different issuers and is always close to the credit limit for each card, and this behavior is typical for people who become delinquent, then the Prediction System 110 may predict that the individual has a higher likelihood of delinquency due to that pattern of behavior. Additional examples of predictions include generating delinquency scores associated with different cards issued to a particular individual, and also assessing the number of delinquent cards of an individual to make predictions. For instance, if an individual has X cards but is delinquent on Y number of cards, then that exact scenario can be looked into (e.g., across all individuals who had X cards but were delinquent on Y number of cards, how many of them became delinquent on another card) and used to make a prediction about this particular individual. Thus, the outcome for multiple cardholders in this exact scenario can be applied to this particular individual.

An example of a prediction made on individual behavior using personal history (e.g., historical data associated with a particular individual), is monitoring how close that individual is to their credit limit over time. If the individual is typically very prompt in paying off their account and stayed well under the limit, but is now using up the card balances, then that could be an indicator of a future delinquency (e.g., the individual has lost their job). The pre-determined thresholds can be used in a similar manner because individuals typically do not hit their threshold often, and if the threshold for multiple cards is reached then that may indicate something is wrong. Thus, as a more specific example, if the individual has typically become delinquent when coming close to the credit limit for previous credit cards, then the Prediction System 110 may predict that the individual has a higher likelihood of delinquency on another credit card that is close to the limit due to that individual's own historical pattern of behavior.

In some embodiments, the Delinquency Score Service 206 may be a machine learning engine. This machine learning engine may have multiple modes of operation, including a learning mode and an applied mode. Under the learning mode, the machine learning engine may use data to build predictive models via any suitable machine learning technique (e.g., supervised machine learning) in order to predict delinquencies. This data may include the aforementioned details associated with the each card associated with an individual, such as credit limit, debt load, threshold, and utilization, but may also include the overall credit utilization for the individual based on all the cards issued to that individual that utilize a single processor computer. The training data used by the Delinquency Score Service 206 may also include delinquency data associated with all individuals. Once enough models of suitable accuracy have been generated, then, under the applied mode, the machine learning engine may then be used to apply the models to up-to-date payment data in order to generate a delinquency score in real time.

In some embodiments, the Delinquency Score Service 206 may be configured to calculate and maintain delinquency scores for each individual based on generated models. In some embodiments, the Delinquency Score Service 206 may periodically calculate the delinquency scores for an individual and call the Utilization Service 208 to obtain the most up-to-date data for the inputs used to calculate the delinquency scores. The Utilization Service 208 may fetch this data from the Utilization Database 210 and/or the Limit Database 214.

In some embodiments, the Delinquency Score Service 206 may generate scores associated with each individual factor used as an input by the Delinquency Prediction Service 204. For instance, if the Delinquency Prediction Service 204 utilizes credit limits and credit utilization as inputs for predicting delinquency, then for any particular card, the Delinquency Score Service 206 may be configured to generate a score for the credit limit and credit utilization. The Delinquency Score Service 206 may also be configured to generate an overall credit utilization score for an individual. The Delinquency Score Service 206 may also store information regarding a user, and multiple accounts that the user is using, and an overall delinquency store or particular delinquency scores for each of the multiple accounts associated with the user. Any or all of this information may be provided in an authorization request message for a transaction so that an issuer can make an authorization determination for the transaction.

In some embodiments, the Delinquency Prediction Service 204 may similarly be a machine learning engine. This machine learning engine may operate in conjunction with the Delinquency Score Service 206 and the up-to-date payment data to predict the delinquency of any payment accounts (e.g., credit card accounts) that are co-related with the current transaction or payment request. In some embodiments, the Delinquency Prediction Service 204 may be able to make predictions regarding whether an individual is going to be delinquent for a particular card, delinquent over a number of cards, or delinquent over a fraction of cards (e.g., of all the total cards) that have been issued to that individual. This prediction will be based on the credit limits, debt loads, utilization, and thresholds associated with those cards, but in some embodiments, may also factor in the credit limits, debt loads, utilization, and thresholds of other cards that have been issued to the individual but for which a prediction is not being generated. In some embodiments, the Delinquency Prediction Service 204 may utilize machine learning techniques that are similar to the Delinquency Score Service 206. However, in some embodiments, a key difference between the Delinquency Prediction Service 204 and the Delinquency Score Service 206 may be that the Delinquency Prediction Service 204 can be used to make real-time decisions regarding authorizing the current transaction or payment request.

In some embodiments, the Delinquency Prediction Service 204 may factor all of the delinquency scores associated with the cards of a particular individual in order to make a delinquency prediction.

In some embodiments, the machine learning engine associated with the Delinquency Prediction Service 204 may have multiple modes of operation, including a fully automated mode and an augmented mode. Under the fully automated mode, one of the Authorizing Entity Computer(s) 112 (e.g., a credit card issuer) may allow the Delinquency Prediction Service 204 to automatically decline a current transaction or payment request in order to avoid the issuer taking on the risk of loss associated with an imminent delinquency scenario for the payment account (e.g., the credit card account) used in the transaction or payment request. Under the augmented mode, the Delinquency Prediction Service 204 may send delinquency prediction scores to the issuer of the payment account used in the transaction or payment request, and that particular issuer may make the actual decision regarding declining the current transaction or payment request to avoid losses in an imminent delinquency scenario.

In some embodiments, the Delinquency Prediction Service 204 and the Delinquency Score Service 206 may be continual learning engines that evolve a set of models and update those models to increase their effectiveness and accuracy.

In some embodiments, the Decisioning Service 202, and not the Delinquency Prediction Service 204, may make the actual decision regarding whether to automatically decline a current transaction or payment request in order to avoid the issuer taking on the risk of loss associated with an imminent delinquency scenario for the payment account (e.g., the credit card account) used in the transaction or payment request. In such embodiments, the Delinquency Prediction Service 204 may be configured to make a prediction regarding the delinquency of the payment account and provide it to the Decisioning Service 202, which may factor that information to arrive at a decision.

In some embodiments, the Decisioning Service 202 and/or the Delinquency Prediction Service 204 may receive authorization request messages in real-time from the Processor Computer 108. For example, a User 102 may attempt to conduct a transaction with the Intermediate Server 106 by providing payment credentials, such as an account identifier associated with their payment account (e.g., a credit card number). The Intermediate Server 106 may submit this information to the Processor Computer 108. Typically, the Processor Computer 108 may send an authorization request message to the Authorizing Entity Computer(s) 112, but in this case, the Processor Computer 208 may send an authorization request message to the Prediction System 110 (e.g., the Decisioning Service 202 and/or the Delinquency Prediction Service 204). If the Prediction System 110 is authorized by the Authorizing Entity Computer(s) 112 to respond to authorization request messages directly, then the Prediction System 110 can authorize or reject the transaction by sending an authorization response message back to the Processor Computer 108.

In some embodiments, the Delinquency Prediction Service 204 may generate delinquency predictions without having to respond to a transaction request (e.g., the Delinquency Prediction Service 204 may periodically generate updated delinquency predictions for every individual). The Delinquency Prediction Service 204 may then proactively reach out to the Authorizing Entity Computer(s) 112 with any potential delinquencies that are discovered. For example, when it is determined that an individual is likely to be delinquent on a card issued by a particular issuer, the Delinquency Prediction Service 204 may inform the issuer that the card is likely to be delinquent by a certain date. In other embodiments, a delinquency score can be added to an authorization request message which can be transmitted to an Authorizing Entity Computer 112 so that it may decide if a transaction is authorized or declined.

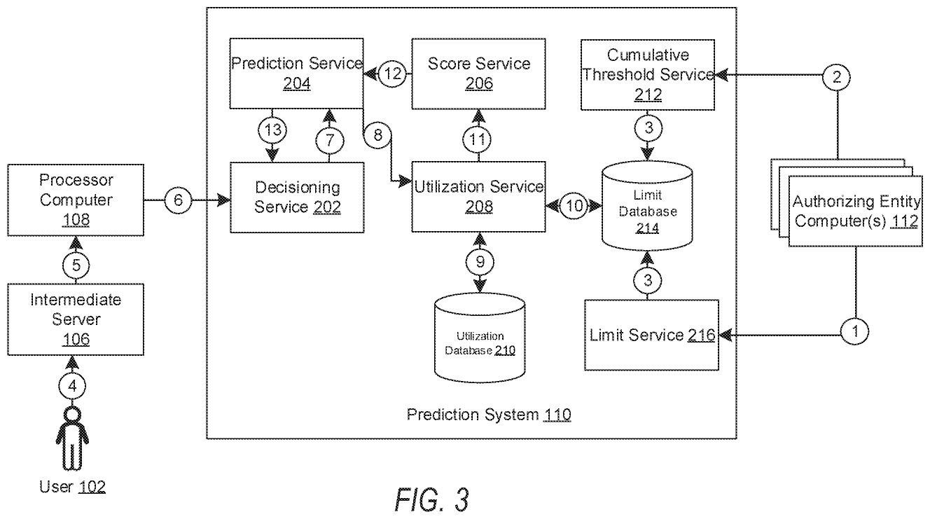

FIG. 3 is a block diagram with an access system and a detailed breakdown of a prediction system in the access system. A process flow is also illustrated in FIG. 3.

FIG. 3 presumes that a basic initialization step has been performed, such that the Authorizing Entity Computer(s) 112 have provided all historical payment account data and delinquency data associated with payment accounts that they have issued. During the initialization of the Prediction System 110, the Authorizing Entity Computer(s) 112 may send data for all existing issued cards and the individuals tied to those cards, in order to build up the Limit Database 214. This may include all available delinquency data, credit limits, debt load, threshold settings, and so forth, for all existing issued cards. The Prediction System 110 will group all the payment accounts for each particular individual and store their payment account data together within the Limit Database 214. This data is then used as training data to generate the models used by the Prediction System 110.

For instance, the Delinquency Score Service 206 may generate predictive models configured to predict an individual's delinquency using training data, which may include the data stored in the Limit Database 214 and/or Utilization Database 210, such as delinquency data, credit thresholds, and events that transpired over the timeline of the card (e.g., historical debt loads, historical transactions, and so forth), for existing cards issued by the Authorizing Entity Computer(s) 112. The Delinquency Score Service 206 may be configured to apply supervised machine learning techniques to this training data in order to generate the model used to predict delinquencies. This model can then be applied in real-time to predict a delinquency associated with a user in a transaction, such as when an authorization request message is received from the Processor Computer (e.g., at circle 6) as shown in the figure. The model may generate this prediction based on details associated with the each card associated with a user attempting to carry out a transaction, such as up-to-date payment or transaction data, the credit limit, the historical debt load, the threshold, utilization, and historical utilization (e.g., how the utilization has changed over the timeline of the card) but may also include the overall credit utilization for the user based on all the cards issued to that user that utilize the Processor Computer 108. The model may also generate this prediction based on delinquency data, and when individuals became delinquent, their utilization over time (e.g., debt load in proportion to the credit limit over time), their overall utilization over time (e.g., total debt load in proportion to the overall credit limit over time), and their overall utilization at the time of delinquency.

In some embodiments, the Delinquency Score Service 206 may inherently assess, through the generated models, whether delinquency is associated with a domino effect (e.g., an individual's delinquencies across multiple cards from various issuers frequently happens successively) or there is a certain period of time between delinquencies. The Delinquency Score Service 206 may also be able to determine the impact of existing delinquencies on future delinquencies (e.g., if an individual is already delinquent on two cards, and the likelihood that the individual will become delinquent on a third card). In some embodiments, this information can be used proactively, such as by informing the Authorizing Entity Computer(s) 112 to lower existing credit limits on cards for the individual.

In some embodiments, the Delinquency Prediction Service 204 may generate predictive models that are capable of utilizing up-to-date payment data to predict the delinquency of any payment accounts (e.g., credit card accounts) that are co-related with the current transaction or payment request. In some embodiments, the Delinquency Prediction Service 204 may be able to make predictions regarding whether an individual is going to be delinquent for a particular card, delinquent over a number of cards, or delinquent over a fraction of cards (e.g., of all the total cards) that have been issued to that individual. This prediction will be based on the credit limits, debt loads, utilization, and thresholds associated with those cards, but in some embodiments, may also factor in the credit limits, debt loads, utilization, and thresholds of other cards that have been issued to the individual but for which a prediction is not being generated. The Delinquency Prediction Service 204 may further be used to make real-time decisions regarding authorizing the current transaction or payment request. It may factor all of the delinquency scores associated with the cards of a particular individual in order to make such a delinquency prediction.

Once these predictive models have been generated and are available to be applied to real-time data, then they can be applied for the purpose of real-time handling transactions and authorization request messages (e.g., circles 4-13 depicted in the figure). However, the Prediction System 110 may update the models with updated data at any time.

At circle 1, the Authorizing Entity Computer(s) 112 may continually inform the Limit Service 216 or Prediction System 110 whenever a new card is issued and provide information regarding the credit limit and account identifier of the card and the details of the individual that card has been issued to. The Limit Service 216 may add the information for the new card to the Limit Database 214. The Authorizing Entity Computer(s) 112 may also provide the Limit Service 216 with updates regarding any changes to existing payment accounts, such as changes to existing credit limits or debt load, and the Limit Service 216 may modify the existing credit limit or debt load on file for that card within the Limit Database 214. In some embodiments, the debt loads for cards will be saved in the Utilization Database 210, so any updates to debt loads will be reflected there. Thus, at circle 3, the Limit Service 216 will manage and store details, (e.g., credit limits, debt loads, account identifiers, associated individual details) associated with previous credit cards or a new credit card that has been issued by the Authorizing Entity Computer(s) 112, in the Limit Database 214.

At circle 2, the Authorizing Entity Computer(s) 112 may inform the Cumulative Threshold Service 212 whenever a new card is issued and provide information regarding the threshold that has been set for that card. The Cumulative Threshold Service 212 may add the threshold for the new card to the Limit Database 214. The Authorizing Entity Computer(s) 112 may also provide the Cumulative Threshold Service 212 with updates regarding any changes to thresholds for existing cards, and the Cumulative Threshold Service 212 may modify the threshold on file for that card within the Limit Database 214. The threshold for each card may be stored alongside the other stored information for that card. This pre-defined threshold may be based on each issuer's risk profile and preferences. The issuer may select this threshold based on an associated risk of delinquency upon that threshold being reached. Different issuers can select different thresholds for each card they issue to an individual and these thresholds are saved into the Limit Database 214. Thus, at circle 3, the Cumulative Threshold Service 212 will manage and store thresholds, associated with previous credit cards or a new credit card that has been issued by the Authorizing Entity Computer(s) 112, in the Limit Database 214.

At circle 2, the Authorizing Entity Computer(s) 112 may also provide the Cumulative Threshold Service 212 with any updates in the delinquency data (e.g., a new delinquency) associated with any existing issued cards that have become delinquent. In some embodiments, the delinquency data for a particular card may capture delinquency over a timeline of the card, such that the exact moment a card became delinquent can be determined. In some embodiments, the delinquency data for a particular card may also include events such as historical transactions or changing debt load for the card over the timeline of the card. Thus, the transactions and changing debt load preceding actual delinquencies can be analyzed across many different cards in order to determine if those events can be predictive of a delinquency and utilized in a predictive model. The Cumulative Threshold Service 212 may save this delinquency data in the Limit Database 214, where delinquency data for the cards of any single individual may be stored together.

As a specific example of this delinquency data, a particular individual may have a first credit card from Issuer A, a second credit card from Issuer B, and a third credit card from Issuer C. The individual may be delinquent on the first and second credit cards but not the third credit card. The delinquency data may also include indications of historical events (e.g., payments, transactions, changes in debt loads, changes in credit limits, a delinquency in the card, and so forth) associated with each card, throughout the timeline of the card (e.g., noting the specific times those historical events occurred). For example, from the delinquency data, it may be determined that X, Y, and Z events happened (in that order) in the first credit card, just prior to the individual becoming delinquent on the first credit card, and this pattern of events may have predictive value.

Data from different Authorizing Entity Computer(s) 112 for a single user may be linked together by common data elements (e.g., name, social security number, address, etc.). In some cases, matches may not be exact (e.g., two different authorizing entity computers may use “Street” may be “St.” to represent a street) and fuzzy matching may be utilized in such situations.

At circle 4, a User 102 may attempt to conduct a transaction with the Intermediate Server 106. The User 102 may provide their payment credentials, such as an account identifier of a payment account. In some embodiments, this may be a credit card number tied to a credit card issued by one of the Authorizing Entity Computer(s) 112. This credit card may be associated with the Processor Computer 108.

At circle 5, the Intermediate Server 106 may generate an authorization request message including transaction details, including the payment credentials supplied by the User 102, to the Processor Computer 108 (e.g., the processor computer associated with the credit card that the User 102 used to conduct the transaction). These transaction details may include additional information, such as the total cost of the transaction, a good or service being purchased in the transaction, and so forth.

At circle 6, the Processor Computer 108 may send the authorization request message to the Decisioning Service 202 of the Prediction System 110. As noted, this authorization request message may include information such as the payment credentials (e.g., an account identifier associated with the credit card used in the transaction) supplied by the User 102, the total cost of the transaction, and so forth.

At circle 7, the Decisionining Service 202 may send these details to the Delinquency Prediction Service 204. The Delinquency Prediction Service 204 may be configured to use the previously-generated predictive models to factor in the consequences of authorizing this transaction, in order to determine if a decision to authorizing the transaction will result in a delinquency. A difference between the Delinquency Prediction Service 204 and the Decisioning Service 202, is that the Delinquency Prediction Service 204 is configured to determine whether a particular card used by the User 102 is close to delinquency, whereas the Decisionining Service 202 is configured to actually make a decision (e.g., respond to the authorization request message) based on that determination. In some embodiments, the Authorizing Entity Computer(s) 112 of the card used by the User 102 may have granted the Prediction System 110 permission to make decisions on transactions and the Decisioning Service 202 will respond to the authorization request message. However, if the Authorizing Entity Computer(s) 112 of the card used by the User 102 does not grant permission, then the Delinquency Prediction Service 204 may simply notify the Authorizing Entity Computer(s) 112 of the predictions on the delinquency. This notification may be in an authorization request message which is sent to the appropriate Authorizing Entity Computer 112.

At circle 8, once the Delinquency Prediction Service 204 receives the transaction details, it may request the Utilization Service 208 to update the overall card utilization that is calculated and maintained by the Utilization Service 208 for the individual, or for the Utilization Service 208 to check that the overall card utilization is up to date. This is because the overall card utilization for the individual may be one of the factors that is considered by the Delinquency Prediction Service 204 in determining whether the particular card used by the User 102 in the transaction is close to delinquency. The Delinquency Prediction Service 204 may provide the Card Utilization Service 208 with details of the transaction initiated by the User 102 (e.g., the account identifier of the payment account or credit card used in the transaction).

At circle 9, the Utilization Service 208 may check the Utilization Database 210 in order to determine if the Card Utilization Service 208 previously calculated the overall card utilization for the User 102 and if that overall card utilization is up to date. In some embodiments, the data for the User 102 in the Utilization Database 210 may already include the account identifier of the payment account or credit card that was indicated in the authorization request message. Thus, the Utilization Service 208 may be able to use that account identifier, received from the Delinquency Prediction Service 204, in order to look up the other data associated with the User 102.

At circle 10, the Utilization Service 208 may also check the Limit Database 214 to see if there have been any updates or changes to the cards issued to the User 102, such as changes in credit limits, debt loads, delinquency events, and so forth.

At circle 11, once the Utilization Service 208 has determined that there have been updates to any of the data for User 102 that are used as inputs in the predictive models (including the overall credit utilization for the User 102, which may need to be first re-calculated by the Utilization Service 208) and that the Utilization Service 208 has obtained the most up-to-date data (e.g., at circles 9 and 10), then the Utilization Service 208 may provide all of that data to the Delinquency Score Service 206 to use as inputs in the predictive models for calculating an updated delinquency score. In some embodiments, the Utilization Service 208 may send data to the Delinquency Score Service 206 to use as inputs in the predictive models for calculating a delinquency score, even if there have not been any changes to that data since the Delinquency Score Service 206 previously calculated a delinquency score for the individual. In some embodiments, if the Utilization Service 208 determines that there have not been updates to the data and it was already in possession of the most up-to-date data, then the Utilization Service 208 may notify the Delinquency Score Service 206 to use the previously-calculated delinquency score for the individual.

At circle 12, the Delinquency Score Service 206 may use the received data from the Utilization Service 208 to calculate an updated delinquency score and provide it to the Delinquency Prediction Service 204. In some embodiments, if the Utilization Service 208 has determined that all the data was already up-to-date, then the Delinquency Score Service 206 may provide the previously-calculated delinquency score without having to calculate it again.

At circle 13, the Delinquency Prediction Service 204 may factor the delinquency score to make a prediction regarding whether the User 102 is likely to be delinquent on the card being used in the transaction. For large transactions, the Delinquency Prediction Service 204 may also factor in the current transaction to determine if the User 102 is likely to be delinquent on the card being used in the transaction (e.g., the current transaction will “push” the card into delinquency). In other words, the Delinquency Prediction Service 204 may factor the delinquency score (e.g., pertaining to the card) and determine the likelihood that the User 102 will be delinquent on this card based on their delinquency in other cards. In addition, the Delinquency Prediction Service 204 may determine, across all the individuals who are delinquent in all of their cards except one at a given time, what is the likelihood those individuals will be delinquent in all cards at some point in time and when will those individuals be delinquent in all their cards. The Delinquency Prediction Service 204 may provide this information to the Decisioning Service 202, which can make the decision regarding whether to authorize the transaction (e.g., the transaction associated with the authorization request message at circle 6). In some embodiments, the Authorizing Entity Computer(s) 112 may provide permission for the Decisioning Service 202 to stop payment and reject the transaction, or if the Authorizing Entity Computer(s) 112 do not provide permission, then the predictions and transaction details can be sent to the Authorizing Entity Computer(s) 112 to make the final decision regarding authorizing the transaction. Thus, the Prediction System 110 would not be used to stop a payment, authorization, or sale, but rather used in an advisory capacity for the Authorizing Entity Computer(s) 112.

Although the above examples specifically describe examples including the calculation of risk scores in payment transactions, it is understood that embodiments can be used to perform other transactions such as transactions to access secure data. For example, referring to FIGS. 1 and 3, the Authorizing Entity Computer(s) 112 could be data access providers that can provide access to secure data (e.g., bank records, tax records, credit bureau data, e-mail servers, etc.). Each Authorizing Entity Computer 112 may have different access credentials (e.g., username and password) tied to a single User 102.

Instead of calculating a delinquency score as in the payment example, the score could be a score indicating a likelihood of account compromise or fraud. In this example, each Authorizing Entity Computer(s) 112 could provide fraud scores, account breaches or compromises, or any other suitable data associated with the User 102. This data could be gathered by a Utilization Service 208 and then provided to the Score Service 206 which scores the access event. The access event may be that the User 102 wishes to use the Access Device 104 (e.g., a laptop computer) to access secure data held by an Authorizing Entity Computer 112. The Prediction Service 204 may then make a prediction as to whether the access event is legitimate or fraudulent, and the Decisioning Service 202 may decide whether or not to allow the User 102 access to the requested secure data held by the Authorizing Entity Computer 112 using the Access Device 104.

The above description is illustrative and is not restrictive. Many variations of the invention may become apparent to those skilled in the art upon review of the disclosure. The scope of the invention may, therefore, be determined not with reference to the above description, but instead may be determined with reference to the pending claims along with their full scope or equivalents. It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software. Any of the software components or functions described in this application, may be implemented as software code to be executed by a processor using any suitable computer language such as, for example, Java, C, C++, Python or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

A recitation of “a”, “an” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

What is claimed is:

1. A method comprising:
receiving, by a computer, on a continual basis, a plurality of indications associated with a user from a plurality of external data sources;
generating, by the computer, a score based upon the plurality of indications;
receiving, by the computer, an authorization request message for a transaction;
applying, by the computer, the score to the authorization request message; and
transmitting, by the computer, an authorization response message based upon the score.

2. The method claim 1, wherein the indications are indications of delinquencies or compromise associated with accounts at the external service providers, the indications including times that any accounts became delinquent or compromised.

3. The method of claim 1, wherein the external data sources are authorizing computers with accounts of the user, and wherein the plurality of indications comprise indications of changes in the accounts the external data sources.

4. The method of claim 3, wherein the plurality of indications further comprise are indications of account utilization.

5. The method of claim 1, wherein the external data sources are authorizing computers with accounts of the user, and wherein the plurality of indications are indications of account utilization.

6. The method of claim 1, wherein the external data sources are authorizing computers with accounts of the user, and wherein the plurality of indications comprise historical account data.

7. The method of claim 6, further comprising:
generating, by the computer, a collective prediction model using at least the historical account data, wherein generating the score includes generating the score using the prediction model and the plurality of indications.

8. The method of claim 1, wherein the authorization request message is received from an access device.

9. The method of claim 1, wherein the access device is a laptop computer, and wherein the authorization request message requests authorization to access sensitive data.

10. The method of claim 1, further comprising:
modifying the authorization request message to include the score; and
transmitting the authorization request message to an authorizing entity computer holding an account used by the user.

11. A computing system comprising:
one or more processors; and
non-transitory memory containing instructions that, when executed by the processor, cause the one or more processors to implement a method comprising:
receiving, on a continual basis, a plurality of indications associated with a user from a plurality of external data sources;
generating a score based upon the plurality of indications;
receiving an authorization request message for a transaction;
applying the score to the authorization request message; and
transmitting an authorization response message based upon the score.

12. The computing system of claim 11, wherein the indications are indications of delinquencies or compromise associated with accounts at the external service providers, the indications including times that any accounts became delinquent or compromised.

13. The computing system of claim 11, wherein the external data sources are authorizing computers with accounts of the user, and wherein the plurality of indications comprise indications of changes in the accounts the external data sources.

14. The computing system of claim 13, wherein the plurality of indications further comprise are indications of account utilization.

15. The computing system of claim 11, wherein the external data sources are authorizing computers with accounts of the user, and wherein the plurality of indications are indications of account utilization.

16. The computing system of claim 11, wherein the external data sources are authorizing computers with accounts of the user, and wherein the plurality of indications comprise historical account data.

17. The computing system of claim 16, further comprising:
generating, by the computer, a collective prediction model using at least the historical account data, wherein generating the score includes generating the score using the prediction model and the plurality of indications.

18. The computing system of claim 11, wherein the authorization request message is received from an access device.

19. The computing system of claim 11, wherein the access device is a laptop computer, and wherein the authorization request message requests authorization to access sensitive data.

20. The computing system of claim 11, further comprising:
modifying the authorization request message to include the score; and
transmitting the authorization request message to an authorizing entity computer holding an account used by the user.
